(19) United States
(12) Patent Application Publication
(10) Pub. No.: US 2026/0198430 A1
(43) Pub. Date: Jul. 16, 2026

(54) SEED SPROUTING KIT

(71) Applicant: BBK Tobacco & Foods, LLP, Phoenix, AZ (US)

(72) Inventor: Ian Paul Kobe, Phoenix, AZ (US)

(73) Assignee: BBK Tobacco & Foods, LLP, Phoenix, AZ (US)

(21) Appl. No.: 19/016,142

(22) Filed: Jan. 10, 2025

(51) Int. Cl. A01G 9/029; A01G 24/25; A01G 24/46; B65D 75/36; B65D 75/56

(52) U.S. Cl. CPC A01G 9/0293; A01G 24/25; A01G 24/46; B65D 75/366; B65D 75/566

(57) ABSTRACT

A preassembled, ready-to-use seed sprouting kit is disclosed. The seed sprouting kit contains plant seeds, sprouting medium, and a sprouting tray. The kit may also include a cover. The see sprouting kit may be fully assembled and packaged within a blister card so that it may be easily displayed.

### TECHNICAL FIELD

This disclosure relates generally to gardening. More specifically, the present invention is a preassembled seed sprouting kit.

### BACKGROUND OF THE INVENTION

Many individuals desire to grow and maintain a home garden. A gardener may wish to grow their plants from seeds or the gardener may wish to plant a seedling instead, depending upon the amount of time needed for the plant to mature. Growing from seeds is often preferred over planting a seedling because it is less expensive to purchase a packet of seeds than it is to purchase a starter plant. Furthermore, there are more varieties of plant seeds that are available year-round while the selection of starter plants may vary according to the season.

For home gardening, several materials are needed to grow plants from seeds; e.g. soil, seed starting mix, seeds, a seed starting tray, and a dome lid to retain moisture. It is difficult to find these materials in small quantities, particularly for a beginning gardener who may only want to try growing one plant for his/her first time. A would-be gardener may even be discouraged from trying to grow a plant for fear that, should he/she have a negative experience and wish to discontinue gardening, he/she will be stuck with a lot of gardening material that he/she no longer needs.

The present disclosure provides for a preassembled and ready-to-use seed sprouting kit. The seed sprouting kit already contains all of the materials needed to begin growing a plant from seeds; all that the user needs to do is to add water to the kit. Other benefits and advantages will become clear from the disclosure provided herein and those advantages provided are for illustration. The statements in this section merely provide the background related to the present disclosure and do not constitute prior art.

### SUMMARY OF THE INVENTION

This summary is provided to introduce a selection of concepts in a simplified form that are further described below in the DESCRIPTION OF THE DISCLOSURE. This summary is not intended to identify key features of the claimed subject matter, nor is it intended to be used as an aid in determining the scope of the claimed subject matter.

In accordance with one or more embodiments of the present invention, a seed sprouting kit is disclosed. The seed sprouting kit has a seed sprouting tray. The seed sprouting kit also has sprouting medium and a plurality of seeds positioned within the sprouting medium. The seed sprouting kit is preassembled.

In accordance with one or more embodiments of the present invention, a seed sprouting kit is disclosed. The seed sprouting kit has a seed sprouting tray. The seed sprouting kit also has sprouting medium and a plurality of seeds positioned within the sprouting medium. The seed sprouting kit also has a cover configured to be removably coupled to the sprouting tray. The seed sprouting kit is preassembled.

In accordance with one or more embodiments of the present invention, a preassembled seed sprouting kit is disclosed. The preassembled seed sprouting kit has a seed sprouting tray. The seed sprouting kit also has a first flat layer of sprouting medium configured to fit within the sprouting tray and a second flat layer of sprouting medium configured to fit within the sprouting tray. A plurality of seeds is positioned between the first layer and the second layer of sprouting medium. The preassembled seed sprouting kit also has a cover configured to be removably coupled to the sprouting tray. The seed sprouting kit also has a blister card for holding the preassembled seed sprouting kit in a fully assembled configuration.

### BRIEF DESCRIPTION OF THE DRAWINGS

The novel features believed to be characteristic of the disclosure are set forth in the appended claims. The disclosure itself, as well as a preferred mode of use, further objectives and advantages thereof, will be best understood by reference to the following detailed description of illustrative embodiments when read in conjunction with the accompanying drawings, wherein:

FIG. 1 is an exploded view of a seed sprouting kit in accordance with one or more embodiments of the present invention; and

FIG. 2 is a perspective view of the sprouting tray of the seed sprouting kit of FIG. 1, where sprouts are shown growing out of the sprouting medium.

### DETAILED DESCRIPTION OF THE INVENTION

The description set forth below in connection with the appended drawings is intended as a description of exemplary embodiments of the disclosure and is not intended to represent the only forms in which the present disclosure may be constructed and/or utilized. The description sets forth the functions and the sequence of blocks for constructing and operating the disclosure in connection with the illustrated embodiments. It is to be understood, however, that the same or equivalent functions and sequences may be accomplished by different embodiments that are also intended to be encompassed within the spirit and scope of this disclosure.

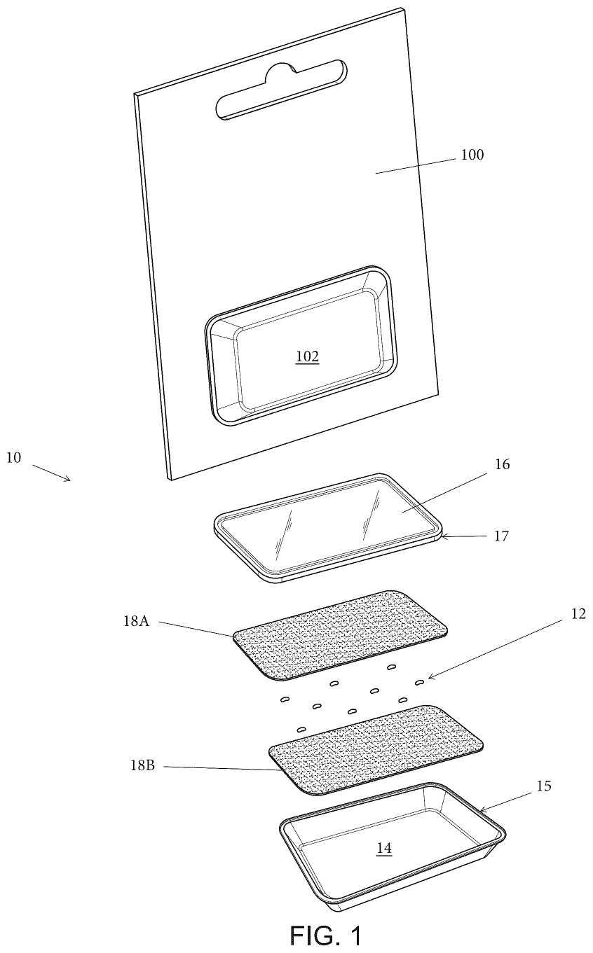

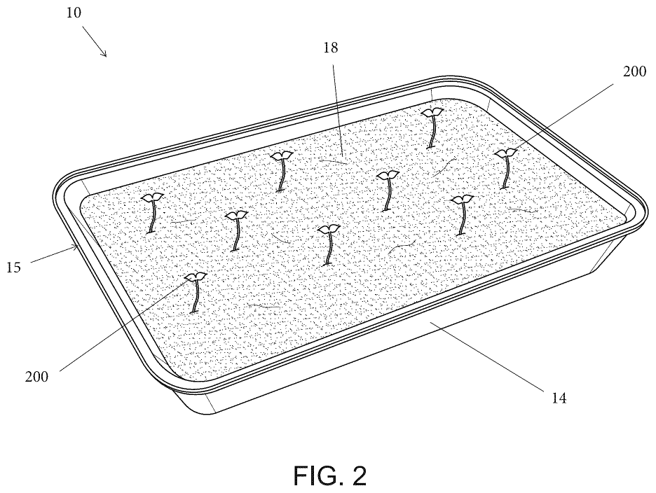

FIGS. 1-2 show a seed sprouting kit 10 in accordance with at least one embodiment of the present invention. The seed sprouting kit 10 is preassembled and ready to use. In its simplest form, the seed sprouting kit 10 comprises seeds 12, a sprouting tray 14, and sprouting medium 18. Optionally, the seed sprouting kit 10 may also include a cover 16 and the seed sprouting kit 10 may also be packaged in a blister card 100.

FIG. 1 shows an exploded view of an embodiment of a seed sprouting kit 10 in accordance with the present invention. The seed sprouting kit 10 will contain seeds 12, a sprouting tray 14, and sprouting medium 18. In one embodiment, each seed sprouting kit 10 may contain one type of seeds 12. In an alternative embodiment, the seed sprouting kit 10 may contain more than one type of seeds 12, as long as all of the seeds 12 in the seed sprouting kit 10 require the same growing conditions.

The sprouting tray 14 may be constructed of aluminum, plastic, or any other suitable material for growing seeds 12. The sprouting tray 14 that is shown has a rectangular shape, but it should be clearly understood that substantial benefit may still be derived by using a sprouting tray 14 having an alternative shape; e.g. square, circular, etc.

The sprouting medium 18 may be coir, organic cotton, or any other suitable natural hydrophilic substance. The sprouting medium 18 may be formed in flat layers that are configured to fit within the body of the sprouting tray 14. As shown, the sprouting medium 18 may be provided in multiple layers. Here, the sprouting kit 10 has a first layer of sprouting medium 18A (referred to generically as sprouting medium 18) and has a second layer of sprouting medium 18B (referred to generically as sprouting medium 18). The seeds 12 will preferably be spaced apart and held in place between the first layer of sprouting medium 18A and the second layer of sprouting medium 18B.

The seed sprouting kit 10 may also include a cover 16. The cover 16 may be made of plastic, glass, or other suitable nonporous material. Covers 16 are often used to help maintain a consistent, high level of humidity around the growing seeds 12, which is crucial for germination to occur. The cover 16 will be configured to be removably coupled to the top of the sprouting tray 14, leaving space above the sprouting medium 18 for the sprouts 200 to grow. In this example, the sprouting tray 14 is rectangular so an open bottom perimeter 17 of the cover 16 is also rectangular and is shaped to mate with the open top perimeter 15 of the rectangular shaped sprouting tray 14.

The seed sprouting kit 10 may be fully contained within a blister card 100. The blister card 100 may be hung or placed on display for a consumer to view. The blister card 100 may have a cut-out 102 formed therein. The cut-out 102 will have the same shape as the assembled seed sprouting kit 10 and will be configured to receive and hold the fully assembled seed sprouting kit 10; i.e. the sprouting tray 14, second layer of sprouting medium 18B, the seeds 12, the first layer of sprouting medium 18A, and the cover 16. Ideally, the blister card 100 will identify the type of seeds 12 contained within the seed sprouting kit 10 within.

When the user is ready to use the seed sprouting kit 10, the user will open the blister card 100 and remove the seed sprouting kit 10. The user may then remove the cover 16, reposition the seeds 12 within the sprouting medium 18, if more spacing is required between the seeds 12, and add water to the sprouting medium 18. The blister card 100 may include instructions on how much water should be added and how often. Because the sprouting medium 18 is a hydrophilic substance, the sprouting medium 18 will absorb the water, thus keeping the water around the seeds 12. In this embodiment, where there is a first layer of sprouting medium 18A and a second layer of sprouting medium 18B, the water will completely surround the seeds 12 from both top and bottom. After the sprouting medium 18 has been saturated with water, the user will place the cover 16 on top of and couple it to the sprouting tray 14 and place the sprouting kit 10 in a dark place.

In time, as shown in FIG. 2, the seeds 12 will ideally germinate and sprouts 200 will grow upwardly through the sprouting medium 18. When the sprouts 200 are strong enough, they may be transferred to a larger container or into the ground.

The foregoing description is provided to enable any person skilled in the relevant art to practice the various embodiments described herein. Various modifications to these embodiments will be readily apparent to those skilled in the relevant art and generic principles defined herein may be applied to other embodiments. Thus, the claims are not intended to be limited to the embodiments shown and described herein, but are to be accorded the full scope consistent with the language of the claims, wherein reference to an element in the singular is not intended to mean “one and only one” unless specifically stated, but rather “one or more.” All structural and functional equivalents to the elements of the various embodiments described throughout this disclosure that are known or later come to be known to those of ordinary skill in the relevant art are expressly incorporated herein by reference and intended to be encompassed by the claims. Moreover, nothing disclosed herein is intended to be dedicated to the public regardless of whether such disclosure is explicitly recited in the claims.

1. A seed sprouting kit comprising:
a seed sprouting tray;
a first flat layer of sprouting medium configured to fit within the sprouting tray;
a second flat laver of sprouting medium configured to fit within the sprouting tray;
a plurality of seeds positioned between the first layer of sprouting medium and the second layer of sprouting medium;
a cover configured to be removably coupled to the sprouting tray; and
a space between the first flat laver of sprouting medium and the cover for sprouts to grow into,
wherein the seed sprouting kit is preassembled, and
wherein the first flat layer of sprouting medium and the second flat layer of sprouting medium configured to completely surround the plurality of seeds with water when soaked.

2. The seed sprouting kit of claim 1, wherein the seed sprouting tray is constructed of aluminum.

3. The seed sprouting kit of claim 1, wherein the sprouting medium is a hydrophilic substance.

4. The seed sprouting kit of claim 3, wherein the hydrophilic substance is one of coir and organic cotton.

5-9. (canceled)

10. The seed sprouting kit of claim 1, wherein the cover is constructed of a nonporous material.

11. The seed sprouting kit of claim 1, further comprising a blister card for holding the seed sprouting kit in a fully assembled configuration.

12. The seed sprouting kit of claim 11, wherein the blister card has a cut-out formed therein, the cut-out being configured to hold a fully assembled seed sprouting kit therein.

13. A seed sprouting kit comprising:
a seed sprouting tray;
a first flat layer of one of coir and organic cotton configured to fit within the sprouting tray;
a second flat layer of one of coir and organic cotton configured to fit within the sprouting tray;
a plurality of seeds positioned between the first laver of one of coir and organic cotton and the second laver of one of coir and organic cotton;
a cover configured to be removably coupled to the sprouting tray; and
a space between the first flat laver of one of coir and organic cotton and the cover for sprouts to grow into,
wherein the seed sprouting kit is preassembled, and
wherein the first flat layer of one of coir and organic cotton and the second flat layer of one of coir and organic cotton are configured to completely surround the plurality of seeds with water when soaked.

14-16. (canceled)

17. The seed sprouting kit of claim 13, further comprising a blister card for holding the seed sprouting kit in a fully assembled configuration.

18. The seed sprouting kit of claim 17, wherein the blister card has a cut-out formed therein, the cut-out being configured to hold a fully assembled seed sprouting kit therein.

19. A preassembled seed sprouting kit comprising:
a seed sprouting tray made of aluminum;
a first flat layer of coir configured to fit within the sprouting tray;
a second flat layer of coir configured to fit within the sprouting tray;
a plurality of seeds positioned between the first flat layer of coir and the second flat layer of coir;
a cover configured to be removably coupled to the sprouting tray;
a space between the first flat layer of coir and the cover for sprouts to grow into; and
a blister card for holding the preassembled seed sprouting kit in a fully assembled configuration,
wherein the first flat layer of coir and the second flat layer of coir are configured to completely surround the plurality of seeds with water when soaked.

20. (canceled)
